(19) United States
(12) Patent Application Publication
(10) Pub. No.: US 2013/0127983 A1
(43) Pub. Date: May 23, 2013

(54) WEB BASED ACCESS TO VIDEO CONTENT ASSOCIATED WITH VOICEMAIL

(71) Applicant: Dany Sylvain, Gatineau (CA)

(72) Inventor: Dany Sylvain, Gatineau (CA)

(73) Assignee: Rockstar Consortium US LP, Plano, TX (US)

(21) Appl. No.: 13/813,008

(22) PCT Filed: Aug. 5, 2010
(86) PCT No.: PCT/IB2010/001955

§ 371 Date: Jan. 29, 2013

(51) Int. Cl. H04N 7/14

(52) U.S. Cl. CPC H04N 7/14
USPC 348/14.12

(57) ABSTRACT

A method for providing access to a video portion of a voice and video (VAV) call includes receiving a VAV call that originated from a device of a first user. The VAV call includes a voice portion and a video portion. The voice portion of the call is transmitted to a voicemail associated with a voice terminal of a second user while the video portion of the VAV call stored. The second user is subsequently provided with access to the video portion of the VAV call.

### FIELD OF THE DISCLOSURE

The present disclosure relates to video sharing, and in particular to allowing access to a video portion of a voice and video call through a web session.

### BACKGROUND

Many modern mobile telephones have the ability to capture video content and share video content with other compatible telephones, which subscribe to a service that supports the sharing of video content. While sharing video content is increasingly desirable, there currently does not exist a convenient way for a video enabled user (e.g., a Session Initialization Protocol (SIP) user or a mobile phone user) to leave a video message to a voice-only user. For example, a mobile user (user A) calls a friend (user B) to share something user A sees. If user B is not present at the time of user A's call and user B's voicemail answers, user A is constrained to leave a message limited to only voice media. Given the apparent desire to share video content and the limited ability to do so, there is a need for an effective and efficient technique to allow users to share video content from their telephones with users who either do not have video compatible voicemail systems or do not subscribe to compatible video sharing services.

### SUMMARY OF THE DETAILED DESCRIPTION

In a communication environment where a video enabled user (user A) calls a called party (user B) having only voice media support, a service node associated with user A records the video media from user A. At a later time, user B may access the service node via a web portal and retrieve the video media recorded from user A.

In an exemplary and non-limiting embodiment, a method for providing access to a video portion of a voice and video call comprises receiving a voice and video (VAV) call that originated from a device of a first user. The VAV call comprises a voice portion and a video portion. The voice portion of the VAV call is transmitted to a voicemail associated with a voice terminal of a second user while the video portion of the VAV call is stored. The second user is subsequently provided with access to the video portion of the VAV call.

In another exemplary and non-limiting embodiment, a method for providing access to a video portion of a VAV call comprises receiving a VAV call that originated from a device of a first user. The VAV call comprises a voice portion and a video portion, wherein the voice portion of the VAV call is separately transmitted to a voicemail associated with a voice terminal of a second user. The video portion of the VAV call is stored and provided to the second user with access to the video portion of the VAV call.

In another exemplary and non-limiting embodiment, a method for associating a video portion of a VAV call that is established at least in part over a circuit-switched connection between a device of a first user and a voice terminal of a second user comprises receiving the video portion of the VAV call via packet based communication and storing the video portion of the VAV call as a stored video portion. The stored video portion is then associated with the second user and the second user is provided with access to the video portion of the VAV call.

Those skilled in the art will appreciate the scope of the present invention and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the invention, and together with the description serve to explain the principles of the invention.

FIG. 1 is a block representation of a communication environment according to one embodiment of the disclosure.

FIGS. 2A and 2B provide an exemplary communication flow according to one embodiment of the disclosure.

FIG. 3 provides a block representation of a communication environment according to an alternative embodiment of the disclosure.

FIG. 4 is a block representation of a service node according to one embodiment of the disclosure.

FIG. 5 is a block representation of a computing device (or voice terminal) according to one embodiment of the disclosure.

### DETAILED DESCRIPTION

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

In an exemplary and non-limiting embodiment, a method for providing access to a video portion of a voice and video (VAV) call comprises receiving a VAV call that originated from a device of a first user. The VAV call comprises a voice portion and a video portion. The voice portion of the VAV call is transmitted to a voicemail associated with a voice terminal of a second user while the video portion of the VAV call is stored. The second user is subsequently provided with access to the video portion of the VAV call. In this manner, the second user, who is unable to receive the video portion of the VAV call in real time, is subsequently enabled to receive the video portion of the VAV call, such as via a web browser.

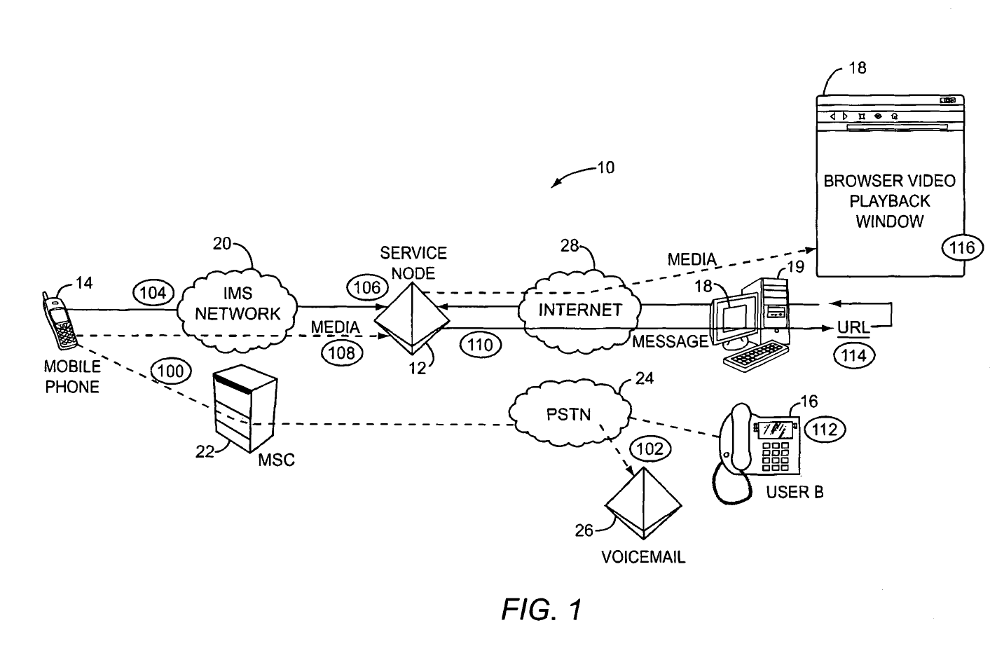

Prior to delving into the details of select embodiments, an overview of an exemplary communication environment 10 is provided in association with FIG. 1. In general, a service node 12 is provided to facilitate communications among a mobile device 14, a voice terminal 16, and a web browser 18, which may be provided on the voice terminal 16 or on a separate computing device 19. Notably, the various terminals and devices 14, 16, 18, 19 may take virtually any form, including wired or wireless telephones, personal computers, personal digital assistants, and the like. The labels provided for these terminals in this description and the following claims are used only to improve readability and separately identify the terminals. As such, any of the terminals (14, 16, 18, 19) may support a limited or full range of multimedia applications and communications, including voice. Alternatively, the voice terminal 16 may support primarily voice communications applications through packet or circuit switched connections.

In general, one embodiment of the present invention allows a first mobile user who is associated with the mobile device 14 to originate a VAV call from the mobile device 14 toward a second user using a communication address associated with the second user in general or the voice terminal 16 in particular. As used herein, “user A” refers to a user of a first user device, such as the mobile device 14, acting as the initiator of a communication to another device associated with another user. Further, “user B” refers to a user of a second device, such as the voice terminal 16 and/or the computing device 19, who is further the intended recipient of a communication from user A. As a result, where appropriate, the term “user A” may be used interchangeably with “the user of the mobile device 14” and “user B” may be used interchangeably with “the user of the voice terminal 16.” During the following discussion wherein there is generally described the operation of the communication environment 10, there are illustrated various step designations (e.g., “step 100”). These step designations, referred to in the Specification, are intended to broadly indicate the flow of information described in the Specification and are illustrated in the figures as element numbers, wherein each element is associated with the step designation.

For example, element number “100” in FIG. 1 is associated with “step 100” described below.

In accordance with an exemplary and non-limiting embodiment, the mobile device 14 is enabled with Global System for Mobile Communications Association (GSMA) Video Share capability. The communications address may be a directory number or packet communications address, such as a Session Initiation Protocol (SIP) uniform resource locator (URL). When the communications address or terminal to which the VAV call is directed is not capable of supporting the video portion of the VAV call, the VAV call is routed to the service node 12 for processing. In the embodiment of FIG. 1, the mobile device 14 is served via an IP Multimedia Subsystem (IMS) network 20 providing access to the service node 12.

In this example, assume the VAV call is directed to the voice terminal 16, which is not capable of supporting the video portion of the VAV call. As illustrated, the VAV call may be directed to the voice terminal 16 via a mobile switching center (MSC) 22 and a public switched telephone network (PSTN) 24 (step 100). As illustrated, the user associated with the voice terminal 16 is not available to answer the VAV call and, as a result, the voice portion of the VAV call is directed to a voicemail 26 (step 102). In accordance with an exemplary embodiment, the mobile device 14 initiates, in parallel, a call comprising the video portion of the VAV call with the service node 12 (step 104). Upon receipt by the service node 12 of the call request from the mobile device 14, the service node 12 instructs the mobile device 14 to send the video portion of the VAV call over the IMS network 20 to a recording port associated with the service node 12 (step 106). In an exemplary embodiment, the service node 12 may request the mobile device 14 to send the audio portion of the VAV call as well for storage on a recording port associated with the service node 12 (step 108).

After receiving and recording the streaming video and optional audio media portions of the VAV call, the service node 12 operates to associate the recorded media portions with a unique identifier to allow for the subsequent secure retrieval of the media content by a user of the voice terminal 16. For example, the media portions may be stored and associated with a phone number of the voice terminal 16 and/or a user identifier of a user of the voice terminal 16, wherein the provision of the phone number and the user identifier is required to gain access to the media portions. In the event that the user of the voice terminal 16 is registered with or otherwise known to the communication environment 10, the service node 12 may send a message to the user of the voice terminal 16 to alert the user to the existence of media stored on the service node 12 and associated with the same VAV call comprising the audio portion stored on the voicemail 26 (step 110). The mode of notification used to send the message to the user may involve, for example, email, instant messaging (IM), short message service (SMS), multimedia messaging service (MMS), and the like. In an exemplary embodiment, and as described more fully below, the message includes a unique URL for accessing the media portions stored on the service node 12. In another exemplary embodiment, the media stored on the service node 12 and associated with the VAV call to user B may be embedded or otherwise included within the message.

At some point, the user of the voice terminal 16 receives a notification that a voicemail message is resident on the voicemail 26. In an exemplary embodiment, the user originating the VAV call indicates in the voicemail message stored on the voicemail 26 that a video portion of the VAV call is stored at the service node 12 and is retrievable via the Internet 28 by accessing a service node Internet portal (step 112). In an alternative embodiment, the user of the voice terminal 16 is alerted to the existence of the video portion of the VAV call stored at the service node 12 via the message including a unique URL described above.

Next, the user of the voice terminal 16 accesses the service node 12 web portal via the operation of the computing device 19 (step 114). In an exemplary embodiment, the user of the voice terminal 16 operates the computing device 19 to access the service node 12 web portal via the Internet 28 communicatively coupling the service node 12 to the computing device 19. If such access is the first time that the user has attempted to access video and/or voice media from the service node 12, the user may be required to create an account in the communication environment 10. Specifically, the user may be required to communicate with the service node 12 over the Internet 28 to establish an account. In an exemplary embodiment, establishing an account includes selecting a user identifier, entering a phone number, such as the phone number of the voice terminal 16, and validating the phone number. Validation of the phone number may be performed by a variety of methods including, but not limited to, the service node 12 calling the user of the voice terminal 16 at the voice terminal 16. In an exemplary embodiment, the account is stored at or accessible to the service node 12 and comprises user profile data associated with the user for whom the account was created. Once an account is created, subsequent access of voice media on the service node 12 by a user merely requires the user to login using the user identifier.

Upon accessing the service node 12 from computing device 19, the user receives one or more records, each corresponding to a unique message from user A stored in a service node recording port. These records are displayed on a graphical user interface (GUI), such as the web browser 18, for selection by user B (step 116). As illustrated, to avoid confusion and to clearly illustrate the operation of the communication environment 10, the operation of the web browser 18 when accessing media from the service node 12 is illustrated in greater detail separate from the operation of the web browser 18 shown as part of the computing device 19 and described in the context of receiving a message from the service node 12. Once selected, a message is sent via the Internet 28 to the service node 12 identifying the video and/or audio media associated with the selected record and the service node 12 proceeds to stream the selected media to the web browser 18.

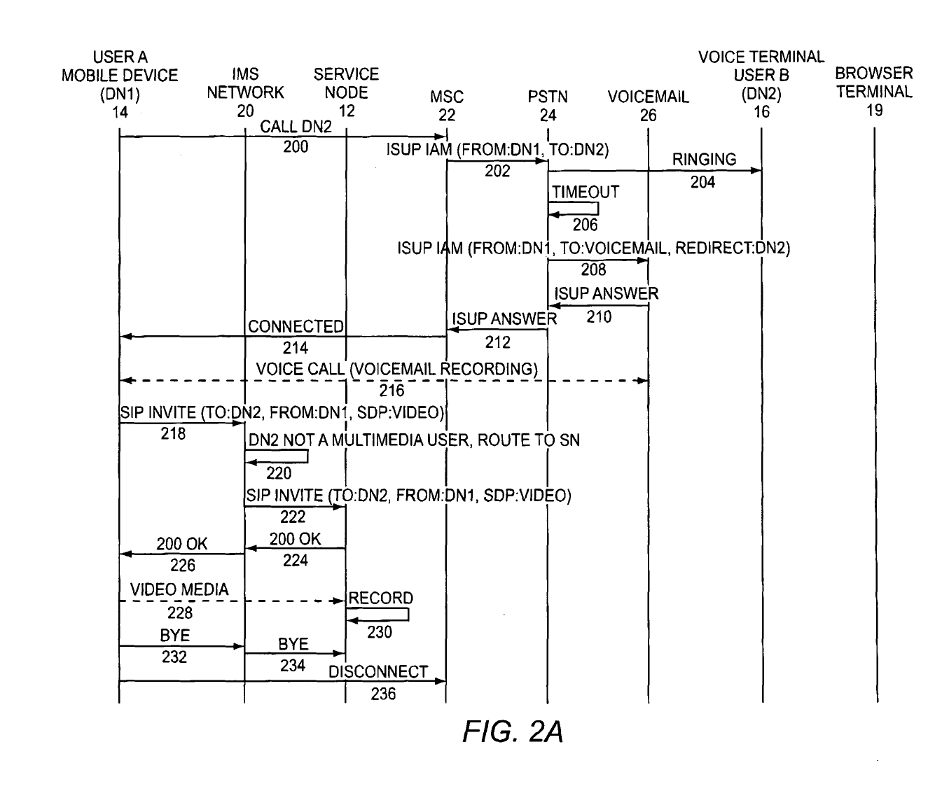

With reference to FIGS. 2A and 2B, a communication flow is provided to illustrate an exemplary scenario for allowing the second user to gain access to the video portion of a VAV call using a computing device 19. Those skilled in the art will recognize that this is only an exemplary scenario according to one embodiment disclosed herein, and the aspects and elements represented in the communication flow are not all deemed necessary for implementation of the present invention. In particular, the communication flow is intended to illustrate numerous optional aspects and features that are supplemental to the core concepts of the embodiments disclosed herein. For this scenario, assume that the second user or the voice terminal 16 is associated with a directory number DN2, while the first user or the mobile device 14 is associated with a directory number DN1.

At some point, the first user decides to initiate a VAV call from the mobile device 14 using the directory number DN1. Accordingly, the first user will instruct the mobile device 14 to make the VAV call, and as such, the mobile device 14 will initiate the VAV call toward the directory number DN2 (step 200). Specifically, the mobile device 14 directs the VAV call to the MSC 22. Upon receipt at the MSC 22, the VAV call is set up in the PSTN 24 as indicated by the ISUP IAM message (step 202). The message continues from the PSTN 24 to the voice terminal 16 whereat the voice terminal 16 rings (step 204). In the exemplary embodiment illustrated, when user B fails to answer the voice terminal 16, the PSTN 24 determines a timeout (step 206) and redirects the VAV call to the voicemail 26 (step 208).

In response to the reception of the VAV call, the voicemail 26 responds to the PSTN 24 with a message indicating “ISUP Answer” (step 210). The PSTN 24 proceeds likewise to inform the MSC 22 of the answer by the voicemail 26 (step 212). The MSC 22 in turn communicates with the mobile device 14 to indicate a connection with the voicemail 26 (step 214). The mobile device 14 proceeds to transmit the voice portion of the VAV call to the voicemail 26 to be recorded at the voicemail 26 (step 216).

In the exemplary embodiment illustrated, it is assumed that SIP is used for video session signaling and control between the mobile device 14 and the service node 12; however, those skilled in the art will recognize that other session signaling protocols may be employed.

While illustrated as following the above discussed steps 200-216, as noted above, the recording of the video portion and/or the voice portion of the VAV call on a service node 12 recording port may take place in parallel with the transmission of the voice portion of the VAV call to the voicemail 26. To initiate the VAV call, the mobile device 14 sends an SIP invite that is intended for the directory number DN2 via the IMS Network 20 (step 218). Upon receipt of the SIP invite, the IMS network 20 determines that the directory number DN2 lacks video media capabilities and proceeds to route the VAV call to the service node 12 (step 220). The IMS network 20 proceeds to send the SIP invite to the service node 12 indicating a call from the directory number DN1 to the directory number DN2 with a Session Description Protocol (SDP) initialization parameter “video” indicating the inclusion of video media data (step 222). When the service node 12 receives the VAV call, the mobile device 14 is informed. Specifically, the service node 12 provides a 200 OK message back to the IMS network 20 (step 224) and on to the mobile device 14 (step 226). Upon receipt of the 200 OK message, the mobile device 14 communicates the video portion and/or the voice portion of the VAV call to the service node 12 (step 228) for recording at a recording port or ports associated with the service node 12 (step 230).

After completing the transmission of the voice portion of the VAV call to the voicemail 26 (step 216) and the video portion of the VAV call to the service node 12 (step 228), the mobile device 14 issues a BYE to the IMS network 20 (step 232) for subsequent transmission to the service node 12 (step 234) indicating the end of the transmission of voice media to the service node 12. At approximately the same time, the mobile device 14 issues a disconnect message to the MSC 22 (step 236). Upon receipt of the disconnect message, the MSC 22 transmits an ISUP release to the PSTN 24 (step 238). In response, the PSTN 24 transmits an ISUP release to the voicemail 26 (step 240) whereupon receipt communication between the mobile device 14 and the voicemail 26 ceases. Therefore, as illustrated, the transmission of the video and/or voice portions of the VAV call to the service node 12 from the mobile device 14 and the transmission of the voice portion of the VAV call to the voicemail 26 are performed in parallel substantially simultaneously while the cessation of each transmission is likewise performed at approximately the same time.

At some point (after step 234) the service node 12 operates to associate the recorded message comprising the video portion and/or the voice portion of the VAV call with the directory number DN2 (step 242). Next, the service node 12 accesses profile information associated with the user of the voice terminal 16 including, for example, an email address of the user B (step 244). The service node 12 proceeds to message user B, such as via an email, utilizing email address information previously retrieved from user B's profile (step 246). In an exemplary embodiment, the email message includes a unique URL at which user B can access the video portion of the VAV call. In another exemplary embodiment, the media stored on the service node 12 and associated with the VAV call to user B may be embedded or otherwise included within the email.

At some point, user B accesses the voice portion of the VAV call from the voicemail 26 (step 248). As noted above, the voice portion of the VAV call may alert user B to the presence of a video portion stored at the service node 12. In an exemplary embodiment, the message recorded on the voicemail 26 may include an automatically generated portion providing information indicating the existence of a video portion of the message and an indication of where and how the video portion may be accessed.

In the instance that user B is informed of the location of the video portion of the VAV call via email, user B retrieves the email and selects or otherwise enters the included unique URL (step 250). In an exemplary embodiment, the email is accessed via the computing device 19, and, more specifically, via the web browser 18. The web browser 18 will identify a URL to use for accessing a video access page, which will help the user gain access to the video portion of the VAV call. In this example, assume the URL is provided to user B via an email and user B enters the URL into the web browser 18, which subsequently sends a video access page request using the URL to the service node 12 (step 252).

Upon receipt of video access page request, the service node 12 sends an authentication request to user B at the computing device 19 (step 254). In response to receiving the authentication request, user B responds to the service node 12 with a message including authentication information such as, for example, a user identifier and password (step 256). Once received by the service node 12, the service node 12 compares the authentication information to the profile of user B to determine if user B is the party for whom the video portion of the VAV call is intended. Assuming that user B is authenticated by the service node 12, the service node 12, acting as an internet server, commences to stream the video portion and/or the voice portion of the VAV call to the computing device 19 for viewing by user B on the web browser 18 (step 258).

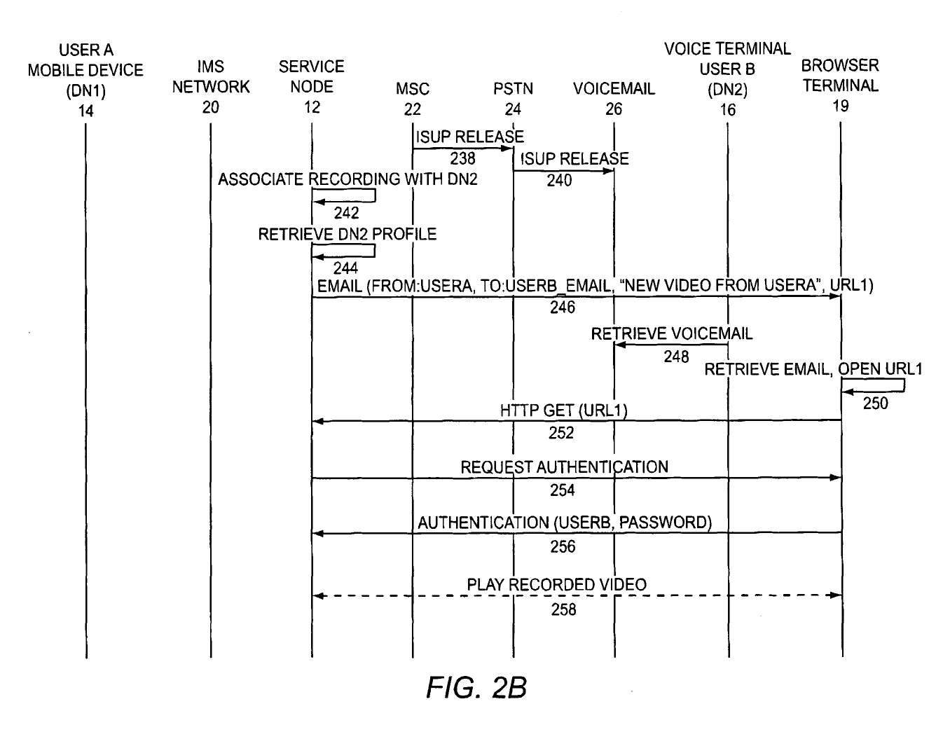

With reference to FIG. 3, an illustration is provided of the communication environment 10 illustrating an exemplary scenario similar to that of FIG. 1 but wherein user A is engaged in all packet based communication absent a circuit connection to the voice terminal 16. In the embodiment illustrated, user A operates a multimedia SIP client running on the computing device 19[1] while user B is enabled to access data from the service node 12 via the computing device 19[2].

In this example, user A at the computing device 19[1] initiates a VAV call to user B at the voice terminal 16 (DN2). As the voice terminal 16 is coupled to the PSTN 24 but is not communicatively coupled to the IMS network 20, the VAV call is routed to the service node 12 (step 300). The service node 12 responds to the computing device 19[1] that the reception of both voice media and video media is possible even though the voice terminal 16 can only support voice media data (step 302). Optionally, the service node 12 may additionally inform the computing device 19[1] that the video media recording is possible at the service node 12. The service node 12 proceeds to initiate a voice-only call to user B at the directory number DN2 via the PSTN 24 (step 304). In the embodiment illustrated, user B does not answer the call and the PSTN 24 directs the call to the voicemail 26 whereat the call is recorded. Because the voicemail 26 is recording only the voice portion of the VAV call, the service node 12 buffers and records in parallel the video media and/or the voice portion of the VAV call at a recording port of the service node 12 (step 306). In one exemplary embodiment, if it is determined that the call to the voice terminal 16 will result in recording only the voice portion of the VAV call on the voicemail 26, the computing device 19[1] may direct the service node 12 to drop the call leg to the voice terminal 16 via the PSTN 24 and continue to buffer and record the video portion and/or the voice portion of the VAV call at a recording port of the service node 12 (step 308).

After receiving and recording the streaming video and optional audio media portions of the VAV call, the service node 12 operates to associate the recorded media portions with a unique identifier to allow for the subsequent secure retrieval of the media content by a user of the voice terminal 16 (step 310). For example, the media portions may be stored and associated with a phone number of voice terminal 16 and/or a user identifier of a user of the voice terminal 16, wherein the provision of the phone number and the user identifier is required to gain access to the media portions. In the event that the user of the voice terminal 16 is registered with or otherwise known to the communication environment 10, the service node 12 may send a message to the user of the voice terminal 16 to alert the user to the existence of media stored on the service node 12 and associated with the same VAV call comprising the audio portion stored on the voicemail 26 (step 312). The mode of notification used to send the message to the user may involve, for example, email, IM, SMS, MMS, and the like. In an exemplary embodiment, and as described more fully below, the message includes a unique URL for accessing the media portions stored on the service node 12. In another exemplary embodiment, the media stored on the service node 12 and associated with the VAV call to user B may be embedded or otherwise included within the message.

At some point, the user of the voice terminal 16 receives a notification that a voicemail message is resident on the voicemail 26. In an exemplary embodiment, the user originating the VAV call indicates in the voicemail message stored on the voicemail 26 that a video portion of the VAV call is stored at the service node 12 and is retrievable via the Internet 28 by accessing a service node Internet portal (step 314). In an alternative embodiment, the user of the voice terminal 16 is alerted to the existence of the video media stored at the service node 12 via the message including a unique URL described above.

Next, the user of the voice terminal 16 accesses the service node 12 web portal via the operation of the computing device 19 (step 316). In an exemplary embodiment, the user of the voice terminal 16 accesses the service node 12 web portal via the Internet 28 communicatively coupling the service node 12 to the computing device 19. If such access is the first time that the user has attempted to access voice media from the service node 12, the user may be required to create an account in the communication environment 10.

Specifically, the user may be required to communicate with the service node 12 over the Internet 28 to establish an account. In an exemplary embodiment, establishing an account includes selecting a user identifier, entering a phone number, such as the phone number of the voice terminal 16, and validating the phone number. Validation of the phone number may performed by a variety of methods including, but not limited to, the service node 12 calling the user of the voice terminal 16 at the voice terminal 16. Once an account is created, subsequent access of voice media on the service node 12 by a user merely requires the user to login using the user identifier.

Upon accessing the service node 12 from the computing device 19, the user receives one or more records, each corresponding to a unique message from user A stored in a service node recording port. These records are displayed on a GUI, such as the web browser 18, for selection by user B. Once selected, a message is sent via the Internet 28 to the service node 12 identifying the video and/or audio media associated with the selected record and the service node 12 proceeds to stream the selected media to the web browser 18 (step 318).

Although the described embodiments assume that user B is not available and that a voicemail system answers the call, it is not an essential step. Instead, user B could answer the call via the PSTN or equivalent voice system and talk with user A while the video is being recorded in the service node 12. Subsequently, user B may access the service node via the web browser 18 to view the video that was recorded.

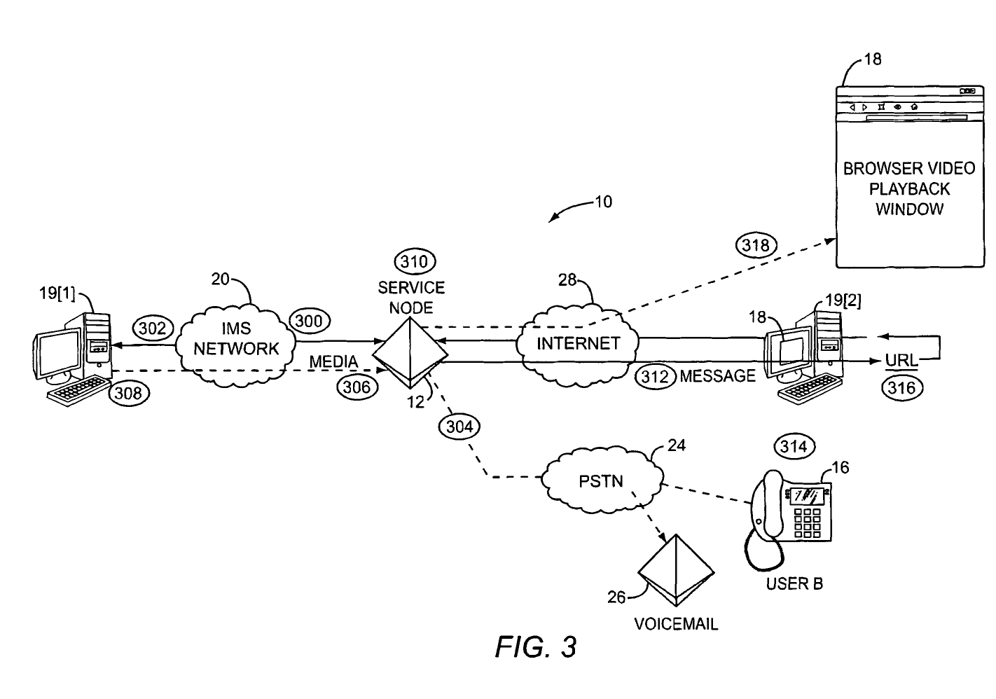

With reference to FIG. 4, a block representation of the service node 12 is illustrated according to one embodiment. The service node 12 may include a control system 30 having sufficient memory 32 for the requisite software 34 and data 36 to operate as described above. The software 34 may provide the communication function, web server function, and interworking function, which are described above. The control system 30 may also be associated with one or more communication interfaces 38 to facilitate communications with the various entities illustrated in the communication environment 10, as well as any other entities being used during the implementation of the present invention.

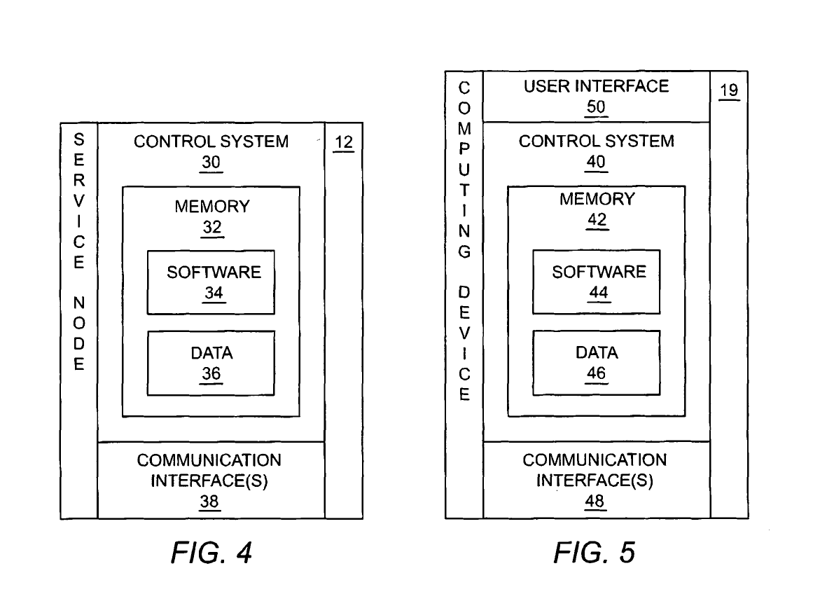

With reference to FIG. 5, a block representation of a computing device 19 (or a voice terminal 16) is illustrated. The computing device 19 may represent a telephone, personal computer, or the like, and may include a control system 40 having sufficient memory 42 for the requisite software 44 and data 46 to operate as described above. The control system 40 may be associated with one or more communication interfaces 48 to facilitate communications as described above, as well as a user interface 50. The user interface 50 may include input devices such as a keypad, mouse, touchscreen, microphone, and the like, as well as one or more output mechanisms, including speakers, displays, and the like.

Those skilled in the art will recognize improvements and modifications to the embodiments of the present invention. All such improvements and modifications are considered within the scope of the concepts disclosed herein and the claims that follow.

What is claimed is:

1. A method for providing access to a video portion of a voice and video (VAV) call comprising:
receiving a VAV call that originated from a device of a first user comprising a voice portion and a video portion;
transmitting the voice portion of the VAV call to a voice system associated with a voice terminal of a second user;
storing the video portion of the VAV call; and
providing the second user with access to the video portion of the VAV call.

2. The method of claim 1 further comprising associating the stored video portion of the VAV call with the second user.

3. The method of claim 2 wherein associating the stored video portion of the VAV call comprises associating the stored video portion of the VAV call with a phone number associated with the voice terminal and a user identifier of the second user.

4. The method of claim 1 wherein providing the second user access to the video portion of the VAV call comprises sending a message to the second user.

5. The method of claim 4 wherein the message is sent via at least one of email, Instant Messaging (IM), Short Message Service (SMS), and Multimedia Messaging Service (MMS).

6. The method of claim 4 wherein the video portion of the VAV call is embedded in the message.

7. The method of claim 4 wherein the message comprises a Uniform Resource Locator (URL) via which the video portion of the VAV call may be accessed.

8. The method of claim 1 wherein providing the second user access to the video portion of the VAV call comprises receiving a request for authentication from the second user, authenticating the second user, and, if the second user is authenticated, streaming the video portion of the VAV call to the second user.

9. The method of claim 8 wherein the request for authentication comprises a user identifier associated with the second user and a password associated with the second user.

10. The method of claim 9 wherein authenticating the second user comprises comparing the user identifier and the password to information associated with a user profile of the second user.

11. The method of claim 1 wherein the device of the first user comprises a mobile device.

12. The method of claim 1 wherein the device of the first user comprises a computing device.

13. The method of claim 1 further comprising storing the voice portion of the VAV call and providing the second user with access to the voice portion of the VAV call.

14. A method for providing access to a video portion of a voice and video (VAV) call comprising:
receiving a VAV call that originated from a device of a first user comprising a voice portion and a video portion, wherein the voice portion of the VAV call is separately transmitted to a voice system associated with a voice terminal of a second user;
storing the video portion of the VAV call; and
providing the second user with access to the video portion of the VAV call.

15. The method of claim 14 further comprising associating the stored video portion of the VAV call with the second user.

16. The method of claim 15 wherein associating the stored video portion of the VAV call comprises associating the stored video portion of the VAV call with a phone number associated with the voice terminal and a user identifier of the second user.

17. The method of claim 14 wherein providing the second user access to the video portion of the VAV call comprises sending a message to the second user.

18. The method of claim 17 wherein the message is sent via at least one of email, Instant Messaging (IM), Short Message Service (SMS), and Multimedia Messaging Service (MMS).

19. The method of claim 17 wherein the video portion of the VAV call is embedded in the message.

20. The method of claim 17 wherein the message comprises a Uniform Resource Locator (URL) via which the video portion of the VAV call may be accessed.

21. The method of claim 14 wherein providing the second user access to the video portion of the VAV call comprises receiving a request for authentication from the second user, authenticating the second user, and, if the second user is authenticated, streaming the video portion of the VAV call to the second user.

22. The method of claim 21 wherein the request for authentication comprises a user identifier associated with the second user and a password associated with the second user.

23. The method of claim 22 wherein authenticating the second user comprises comparing the user identifier and the password to information associated with a user profile of the second user.

24. The method of claim 14 wherein the device of the first user comprises a mobile device.

25. The method of claim 14 wherein the voice portion of the VAV call is separately transmitted to the voice system via circuit switched communication.

26. The method of claim 14 further comprising storing the voice portion of the VAV call and providing the second user with access to the voice portion of the VAV call.

27. A method for associating a video portion of a voice and video (VAV) call that is established at least in part over a circuit-switched connection between a device of a first user and a voice terminal of a second user comprising:
receiving the video portion via packet based communication;
storing the video portion as a stored video portion;
associating the stored video portion with the second user; and
providing the second user with access to the video portion.

28. The method of claim 27 wherein providing the second user access to the video portion of the VAV call comprises sending a message to the second user.

29. The method of claim 28 wherein the message is sent via at least one of email, Instant Messaging (IM), Short Message Service (SMS), and Multimedia Messaging Service (MMS).

30. The method of claim 28 wherein the video portion of the VAV call is embedded in the message.
